(19) United States
(12) Patent Application Publication
(10) Pub. No.: US 2013/0198523 A1
(43) Pub. Date: Aug. 1, 2013

(54) METHOD AND APPARATUS FOR CHECKING FIELD REPLACEABLE UNIT, AND COMMUNICATION DEVICE

(71) Applicant: Huawei Technologies Co., Ltd., Shenzhen (CN)

(72) Inventors: Tao Wu, Shenzhen (CN); Jianxiong Wei, Beijing (CN); Zhonghua Deng, Shenzhen (CN)

(73) Assignee: Huawei Technologies Co., Ltd., Shenzhen (CN)

(21) Appl. No.: 13/714,127

(22) Filed: Dec. 13, 2012

(30) Foreign Application Priority Data
Dec. 16, 2011 (CN) 201110424365.3

(51) Int. Cl. G06F 21/31

(52) U.S. Cl. CPC G06F 21/31
USPC 713/182

(57) ABSTRACT

The present application provides a method and an apparatus for checking a field replaceable unit, and a communication device. The method for checking the field replaceable unit includes: obtaining key identifier information saved in a security memory module; and determining trustworthiness of the field replaceable unit according to the key identifier information saved in the security memory module and key identifier information directly obtained from the field replaceable unit. The present application may implement trustworthiness checking of the field replaceable unit, the implementation is simple, and the cost is low.

### CROSS REFERENCE TO RELATED APPLICATION

This application claims priority to Chinese Patent Application No. 201110424365.3, filed on Dec. 16, 2011, which is hereby incorporated by reference in its entirety.

### FIELD OF THE APPLICATION

The present application relates to the field of communications technologies, and in particular, to a method and an apparatus for checking a field replaceable unit, and a communication device.

### BACKGROUND

The concept of a field replaceable unit (Field replaceable unit; hereinafter briefly referred to as: FRU) is initially proposed from the perspective of technical services. When a device is faulty in running due to hardware damage, only a corresponding faulty field replaceable unit needs to be replaced. In this way, it is avoided that the whole device is returned to the manufacturer for repair, repair efficiency is also improved, and the repair cost is reduced.

For example, hardware related to the field replaceable unit may be classified into two types. One is a communication device, including a stored program control telephone switching system, a data communication device, a wireless communication device, an optical transmission device and so on, and the other is a server type device, including a minicomputer, a server and a computer.

For the communication device, from the whole device to a power module, a replaceable optical component on a board, and so on, are all field replaceable units. For the minicomputer, the server or a computer terminal and so on, a typical field replaceable unit includes a board card, a power supply, a chassis component, and so on.

In the field of security, trustworthiness is a requirement for anti-spoofing, non-repudiation, anti-modification and/or anti-leakage. For the field replaceable unit, trustworthiness refers to end-to-end security of the field replaceable unit in an installation process, a supply chain process, and a return and repair process, and it is ensured that no illegal hardware or software is installed in the field replaceable unit in links of delivery, transportation, installation, return and repair, and so on.

There are mainly two solutions for checking the trustworthiness of the FRU in the prior art, one is replacement management based on an electronic label, and the other is a trustworthiness solution that is applied to a computer system and is based on a trusted platform module (Trusted Platform Module; hereinafter briefly referred to as: TPM) chip.

The replacement management based on the electronic label is to store information, such as the type of the FRU, into a non-volatile (Non volatile) memory component of the FRU, where the stored information may be written, read and modified, and operations such as network installation, upgrade and capacity expansion, client problem handling, spare part management batch replacement and so on may be performed by using the electronic label, which achieves effects of improving efficiency and optimizing informatization. The non-volatile memory component usually refers to a memory component which has no loss after power-off, for example, a flash memory (Flash Memory), an erasable programmable read-only memory (Erasable Programmable Read-Only Memory, EPROM), an electrically erasable programmable read-only memory (Electrically Erasable Programmable Read-Only Memory), a hard disk, and so on.

According to the solution, the hardware is easy to be stealthily substituted and an identifier is easy to be forged in a logistics process or in an FRU running status. However, the trustworthiness of the FRU cannot be detected in the replacement management based on the electronic label.

The trustworthiness solution based on the TPM chip is mainly used in the computer system at present. The TPM chip is actually a small system-on-chip including a password computing component and a memory component, and may assist the computer system to complete operations such as random number generating, key, encryption and/or authentication and so on. These operations are completed inside the TPM chip and authentication is needed for these operations, thereby having higher security.

However, in the trustworthiness solution based on the TPM chip, hardware of a small system needs to be added, and corresponding software needs to be developed. Implementation is complex, the cost is high, and the existing solution is largely changed, which is not good for smooth upgrade of a product.

### SUMMARY

The present application provides a method and an apparatus for checking a field replaceable unit, and a communication device, so as to implement trustworthiness checking of the field replaceable unit.

In one aspect, a method for checking a field replaceable unit, including:

obtaining key identifier information saved in a security memory module; and

determining trustworthiness of the field replaceable unit according to the key identifier information saved in the security memory module and key identifier information directly obtained from the field replaceable unit.

In another aspect, an apparatus for checking a field replaceable unit, including:

an obtaining module, configured to obtain key identifier information saved in a security memory module; and

a determining module, configured to determine trustworthiness of the field replaceable unit according to the key identifier information that is saved in the security memory module and obtained by the obtaining module and key identifier information that is directly obtained from the field replaceable unit.

In still another aspect, a communication device, including: at least one field replaceable unit and at least one apparatus as described in the foregoing for checking the field replaceable unit.

According to the embodiments of the present application, after the key identifier information saved in the security memory module is obtained, the trustworthiness of the field replaceable unit may be determined according to the key identifier information saved in the security memory module and the key identifier information directly obtained from the field replaceable unit, thereby implementing trustworthiness checking of the field replaceable unit, the implementation is simple, and the cost is low.

### BRIEF DESCRIPTION OF THE DRAWINGS

To illustrate the technical solutions according to the embodiments of the present application or in the prior art more clearly, accompanying drawings for describing the embodiments or the prior art are introduced briefly in the following. Obviously, the accompanying drawings in the following description are merely some embodiments of the present application, and persons of ordinary skill in the art may obtain other drawings from the accompanying drawings without making creative efforts.

FIG. 1 is a flow chart of an embodiment of a method for checking a field replaceable unit according to the present application;

FIG. 2 is a schematic structural diagram of an embodiment of an apparatus for checking a field replaceable unit according to the present application; and

FIG. 3 is a schematic structural diagram of another embodiment of an apparatus for checking a field replaceable unit according to the present application.

### DETAILED DESCRIPTION OF THE EMBODIMENTS

To make the objectives, technical solutions, and advantages of the embodiments of the present application clearer, the following describes the technical solutions in the embodiments of the present application in detail with reference to the accompanying drawings in the embodiments of the present application. Obviously, the embodiments in the following description are merely part of rather than all of the embodiments of the present application. All other embodiments obtained by persons of ordinary skill in the art based on the embodiments of the present application without making creative efforts shall fall within the protection scope of the present application.

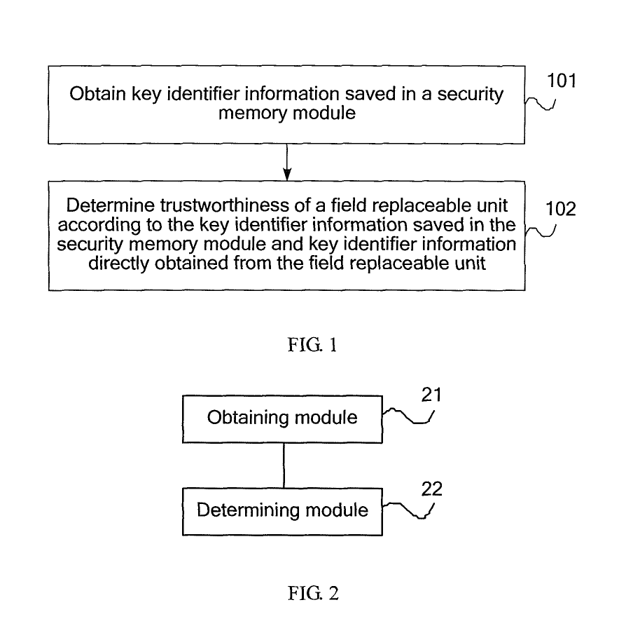

FIG. 1 is a flow chart of an embodiment of a method for checking a field replaceable unit according to the present application, and as shown in FIG. 1, the method for checking the field replaceable unit may include:

101: Obtain key identifier information saved in a security memory module.

The security memory module may be a module in the field replaceable unit, and generally speaking, may be hardware, that is, a certain non-volatile memory component or a part of a certain non-volatile memory component.

102: Determine trustworthiness of the field replaceable unit according to the key identifier information saved in the security memory module and key identifier information directly obtained from the field replaceable unit.

Specifically, the determining the trustworthiness of the field replaceable unit according to the key identifier information saved in the security memory module and the key identifier information directly obtained from the field replaceable unit may be:

comparing the key identifier information saved in the security memory module with the key identifier information directly obtained from the field replaceable unit; if the key identifier information saved in the security memory module is consistent with the key identifier information directly obtained from the field replaceable unit, determining that the field replaceable unit is trustworthy; and if the key identifier information saved in the security memory module is inconsistent with the key identifier information directly obtained from the field replaceable unit, determining that the field replaceable unit is untrustworthy.

In this embodiment, if the key identifier information saved in the security memory module includes: encrypted key identifier information, the comparing the key identifier information saved in the security memory module with the key identifier information directly obtained from the field replaceable unit may be: decrypting the encrypted key identifier information saved in the security memory module, and comparing the decrypted key identifier information with the key identifier information directly obtained from the field replaceable unit; or, encrypting the key identifier information directly obtained from the field replaceable unit, and comparing the key identifier information, which is directly obtained from the field replaceable unit and is encrypted, with the encrypted key identifier information saved in the security memory module, where an encryption algorithm adopted to encrypt the key identifier information directly obtained from the field replaceable unit is the same as an encryption algorithm adopted in the encrypted key identifier information saved in the security memory module.

The encrypted key identifier information saved in the security memory module may include one or any combination of the following: a ciphertext of an electronic identifier used to uniquely identify the field replaceable unit, a digest ciphertext of an identifier and topology of a key chip in the field replaceable unit, a digest ciphertext of a read only memory (Read Only Memory; hereinafter briefly referred to as: ROM) program area in the field replaceable unit, and a digest ciphertext of a system software program area or another software program area except the system software program area in the field replaceable unit.

Specifically, the decrypting the encrypted key identifier information saved in the security memory module, and comparing the decrypted key identifier information with the key identifier information directly obtained from the field replaceable unit may be:

decrypting the ciphertext of the electronic identifier used to uniquely identify the field replaceable unit and saved in the security memory module, and comparing the decrypted electronic identifier with an electronic identifier directly read from the field replaceable unit; and/or

decrypting the digest ciphertext of the identifier and the topology of the key chip in the field replaceable unit, where the digest ciphertext is saved in the security memory module, generating a digest of an identifier and topology of the key chip in the field replaceable unit according to the identifier and the topology of the key chip in the field replaceable unit, where the identifier and the topology are directly read from the field replaceable unit, and comparing the decrypted digest of the identifier and the topology of the key chip in the field replaceable unit with the generated digest of the identifier and the topology of the key chip in the field replaceable unit; and/or

decrypting the digest ciphertext of the ROM program area in the field replaceable unit, where the ciphertext is saved in the security memory module, generating a digest of a ROM program area in the field replaceable unit according to information of the ROM program area in the field replaceable unit, where the information of the ROM program area is directly read from the field replaceable unit; and comparing the decrypted digest of the ROM program area in the field replaceable unit with the generated digest of the ROM program area in the field replaceable unit; and/or,

decrypting the digest ciphertext of the system software program area or another software program area except the system software program area in the field replaceable unit, where the digest ciphertext is saved in the security memory module, generating a digest of a system software program area or another software program area except the system software program area in the field replaceable unit according to information of the system software program area or another software program area except the system software program area in the field replaceable unit, where the information is directly read from the field replaceable unit, and comparing the decrypted digest of the system software program area or another software program area except the system software program area in the field replaceable unit with the generated digest of the system software program area or another software program area except the system software program area in the field replaceable unit.

Optionally, after 102, the trustworthiness of the field replaceable unit may be stored in a system status memory module. The system status memory module is generally placed on a main control board or a trustworthiness management module of a network management system. Implementation of the system status memory module is not limited in the embodiment of the present application, status information may be stored in a random access memory (Random Access Memory; hereinafter briefly referred to as: RAM), and some information may need to be stored in a non-volatile memory. Definitely, the system status memory module may also be implemented by adopting software.

Specifically, in this embodiment, the obtaining the key identifier information saved in the security memory module in 101 may be:

after the field replaceable unit is received, and before the field replaceable unit is used for the first time, obtaining the key identifier information saved in the security memory module of the field replaceable unit; or

in a start process of the field replaceable unit, obtaining the key identifier information saved in the security memory module of the field replaceable unit; or

after a field replaceable unit is newly inserted, obtaining key identifier information saved in a security memory module of the newly inserted field replaceable unit; or

in a running process of the field replaceable unit, regularly or periodically obtaining the key identifier information saved in the security memory module of the field replaceable unit; or

in a running process of the field replaceable unit, receiving the key identifier information that is saved in the security memory module of the field replaceable unit and is reported by the field replaceable unit after the field replaceable unit is triggered by a command.

In this embodiment, in the start process of the field replaceable unit, if it is determined that the field replaceable unit is trustworthy, the field replaceable unit is allowed to be registered, the electronic identifier used to uniquely identify the field replaceable unit is saved in the system status memory module, and after the field replaceable unit is successfully registered, a status of the field replaceable unit in the system status memory module is updated to an online status; while if it is determined that the field replaceable unit is untrustworthy, an alarm is generated, and an event that the field replaceable unit is untrustworthy is recorded in a log.

After the field replaceable unit is newly inserted, if it is determined that the newly inserted field replaceable unit is trustworthy, the newly inserted field replaceable unit is allowed to be registered, an identifier of the field replaceable unit corresponding to a slot number of the newly inserted field replaceable unit in the system status memory module is updated to an electronic identifier used to uniquely identify the newly inserted field replaceable unit, and after the newly inserted field replaceable unit is successfully registered, a status of the newly inserted field replaceable unit in the system status memory module is updated to an online status.

After the field replaceable unit is newly inserted, if it is determined that the newly inserted field replaceable unit is untrustworthy, an alarm is generated, and an event that the newly inserted field replaceable unit is untrustworthy is recorded in a log.

In the running process of the field replaceable unit, if it is determined that the field replaceable unit is untrustworthy, the field replaceable unit is brought offline, a status of the field replaceable unit in the system status memory module is updated to an offline status, alarm information is output, and an event that the field replaceable unit is untrustworthy is recorded in a log.

In the foregoing embodiment, after the key identifier information saved in the security memory module of the field replaceable unit is obtained, the trustworthiness of the field replaceable unit may be determined according to the key identifier information saved in the security memory module and the key identifier information directly obtained from the field replaceable unit, thereby implementing trustworthiness checking of the field replaceable unit, the implementation is simple, and the cost is low.

The method provided in the embodiment of the present application may support the trustworthiness checking on receiving of the field replaceable unit, that is, after the field replaceable unit is delivered or returned after repair, a consignee checks the trustworthiness of the hardware and software of the received field replaceable unit.

The method provided in the embodiment of the present application may further support start security of the field replaceable unit, that is, after the field replaceable unit is inserted into a system, according to the method provided in the embodiment of the present application, necessary information of the field replaceable unit may be recorded, and the trustworthiness checking may be performed on the field replaceable unit; only the trustworthy field replaceable unit may be accepted and used by the system.

According to the method provided in the embodiment of the present application, trustworthiness checking may also be performed on the field replaceable unit in the running process of the field replaceable unit, that is, in a running status, the trustworthiness checking of the field replaceable unit may be initiated actively, regularly or periodically, thereby ensuring the trustworthiness of the field replaceable unit in real time.

According to the embodiment of the present application, a non-volatile memory module with a limited write authority, which is referred to as a security memory module (Security Memory; hereinafter briefly referred to as: Security MEM) here, is newly added in the field replaceable unit (FRU). In the embodiment of the present application, strict identity authentication or a specific tool is needed in order to perform a write operation to the Security MEM, and an event that the write operation is performed on the Security MEM and the identity authentication information need to be recorded in a security log. The identity authentication may be that only a user with specific authority can write in the Security MEM. The specific tool may be a special interface reserved in the hardware, for example, an asynchronous transfer standard interface—RS232 interface specified by the Electronic Industries Association (Electronic Industries Association; hereinafter briefly referred to as: EIA), a Joint Test Action Group (Joint Test Action Group; hereinafter briefly referred to as: JTAG) interface or a self-defined interface, and these special interfaces can only be written by using special interface tools.

In the embodiment of the present application, the Security MEM, built in the FRU, is configured to store the encrypted key identifier information of the FRU, and may be divided into multiple independent memory areas. The encrypted key identifier information may at least include one or any combination of the following information.

1) The ciphertext of the electronic identifier used to uniquely identify the FRU. For example, an encrypted ciphertext of the electronic label.

2) The digest ciphertext of the identifier and the topology of the key chip in the FRU. The identifier of the key chip may be an identifier (chip ID), a version or a chip type built in the key chip, and the topology of the key chip may be connection information of a Joint Test Action Group (Joint Test Action Group; hereinafter briefly referred to as: JTAG) scan chain. All the foregoing information may be recorded, or a digest may be obtained by using a one-way function.

3) The digest ciphertext of the ROM program area (the part that is unchanged during normal running) in the FRU.

4) The digest ciphertext of the system software program area or another software program area except the system software program area in the FRU.

The encrypted key identifier information saved in the Security MEM is encrypted in a manner agreed by both parties (the consigner and the consignee). If an asymmetric encryption manner is adopted, a public key may be saved in the system status memory module (System Status Memory; hereinafter briefly referred to as: SysStatus MEM).

The SysStatus MEM is generally placed on the main control board of a device or the trustworthiness management module of the network management system. The SysStatus MEM is mainly configured to record a trustworthiness status of each FRU in the system, and store some public information used for checking. Through the information stored in the SysStatus MEM, the trustworthiness status of each FRU in the whole system may be seen conveniently, and a situation of trustworthiness operation performed by the system may be learnt.

The information stored in the SysStatus MEM may at least include one or any combination of the following information:

1) the electronic identifier used to uniquely identify each FRU, and presence status information and trustworthiness checking information of each FRU;

2) the trustworthiness alarm information;

3) the trustworthiness log; and

4) optionally, information, such as the encryption algorithm, a key used for encryption, or the public key used for asymmetric encryption and so on, may also be included.

Generally, multiple authority statuses are divided for the SysStatus MEM, for example, a status area indicates running status information of the system, and is used in program update control; and some fixed information is placed in an information area, which requires stricter authority control.

A method for checking sending of a sender and a method for checking receiving of a receiver are introduced in the following.

In the embodiment of the present application, the method for checking sending of the sender may include:

1: obtaining, by the sender, write permission of the Security MEM; and

2: extracting, by the sender, the key identifier information of the FRU, encrypting the key identifier information by using the agreed encryption manner, and then storing the information in the Security MEM.

Strict identity authentication or a specific tool is needed in order to perform the write operation to the Security MEM, and an event that the write operation is performed on the Security MEM and the identity authentication information need to be recorded in the security log.

In the embodiment of the present application, the method for checking receiving of the receiver may include:

1: obtaining, by the receiver, the encrypted key identifier information saved in the Security MEM of the FRU, decrypting the encrypted key identifier information, and comparing it with the key identifier information directly obtained from the FRU; and

2: if the key identifier information obtained after the encrypted key identifier information saved in the Security MEM is decrypted is the same as the key identifier information directly obtained from the FRU, determining that the FRU is trustworthy.

Dynamic checking of the FRU is introduced in the following.

In the embodiment of the present application, the dynamic checking of the FRU includes the following cases.

1: In the start process of the FRU, the trustworthiness checking is performed on the FRU.

Specifically, after the FRU is inserted into the system, the main control board of the device or a device management system of the network management system may obtain the key identifier information saved in the Security MEM of the FRU, and then determine the trustworthiness of the FRU according to the key identifier information saved in the Security MEM and the key identifier information directly obtained from the FRU. Specifically, the trustworthiness checking may be that all or part of the key identifier information of the FRU is checked, and during checking, the key identifier information that needs to be checked is checked in turn. If a check error is found in any information of the key identifier information, an alarm is generated, and the checking process is stopped.

Finally, the system determines, according to the trustworthiness of the FRU, whether the FRU is allowed to be registered in the system. Specifically, if it is determined that the FRU is trustworthy, the FRU is allowed to be registered, the electronic identifier used to uniquely identify the FRU is saved in the SysStatus MEM, and after the FRU is successfully registered, the status of the FRU in the SysStatus MEM is updated to the online status. If it is determined that the FRU is untrustworthy, the FRU is not allowed to be registered, an alarm is generated, and the event that the FRU is untrustworthy is recorded in the log.

2: In the running process of the FRU, the trustworthiness checking is performed on the FRU.

Specifically, in the running process of the FRU, the key identifier information saved in the Security MEM of the FRU may be obtained regularly or periodically, or the key identifier information that is saved in the Security MEM of the FRU and is reported by the FRU after the FRU is triggered by a command may be received; and then, the trustworthiness of the FRU is determined according to the key identifier information saved in the Security MEM and the key identifier information directly obtained from the FRU. Likewise, the trustworthiness checking may be that all or part of the key identifier information of the FRU is checked, and during checking, the key identifier information that needs to be checked is checked in turn. If a check error is found in any information of the key identifier information, an alarm is generated, and the checking process is stopped.

In the running process of the FRU, if it is determined that the FRU is trustworthy, the result of the trustworthiness checking is output. If it is determined that the FRU is untrustworthy, the FRU is brought offline, the status of the FRU in the SysStatus MEM is updated to the offline status, the alarm information is output, and the event that the FRU is untrustworthy is recorded in the log.

3: The FRU supports hot plugging. In the running process of the system, an FRU is inserted, key identifier information saved in a Security MEM of the newly inserted FRU may be obtained in the same way, and the trustworthiness of the FRU is determined according to the key identifier information saved in the Security MEM and key identifier information directly obtained from the newly inserted FRU. Likewise, the trustworthiness checking may be that all or part of the key identifier information of the newly inserted FRU is checked, and during checking, the key identifier information that needs to be checked is checked in turn. If a check error is found in any information of the key identifier information, an alarm is generated, and the checking process is stopped.

If it is determined that the newly inserted FRU is trustworthy, the newly inserted FRU is allowed to be registered, an identifier of the FRU corresponding to a slot number of the newly inserted FRU in the SysStatus MEM is updated to an electronic identifier used to uniquely identify the newly inserted FRU, and after the newly inserted FRU is successfully registered, the status of the newly inserted FRU in the SysStatus MEM is updated to the online status. If it is determined that the newly inserted FRU is untrustworthy, the newly inserted FRU is not allowed to be registered, an alarm is generated, and the event that the newly inserted FRU is untrustworthy is recorded in the log.

In the embodiment of the present application, after the FRU is unplugged, the status of the FRU in the SysStatus MEM is updated to unplugged.

Particularly, the trustworthiness checking may be performed on a replaced FRU in the same manner after the FRU is replaced due to service adjustment. Specifically, key identifier information saved in the Security MEM of the replaced FRU may be obtained, and trustworthiness of the replaced FRU is determined according to the key identifier information saved in the Security MEM and key identifier information directly obtained from the replaced FRU. Likewise, the trustworthiness checking may be that all or part of the key identifier information of the replaced FRU is checked, and during checking, the key identifier information that needs to be checked is checked in turn. If a check error is found in any information of the key identifier information, an alarm is generated, and the checking process is stopped.

If it is determined that the replaced FRU is trustworthy, the replaced FRU is allowed to be registered, an identifier of the FRU corresponding to a slot number of the replaced FRU in the SysStatus MEM is updated to an electronic identifier used to uniquely identify the replaced FRU, and after the replaced FRU is successfully registered, a status of the replaced FRU in the SysStatus MEM is updated to the online status. If it is determined that the replaced FRU is untrustworthy, the replaced FRU is not allowed to be registered, an alarm is generated, and an event that the replaced FRU is untrustworthy is recorded in the log.

In the description of the dynamic checking process of the FRU, reference may be made to the description in the embodiment shown in FIG. 1 of the present application for the determining the trustworthiness of the FRU according to the key identifier information saved in the Security MEM and the key identifier information directly obtained from the FRU, which is not repeatedly described here.

With the method for checking the field replaceable unit provided in the embodiment of the present application, the trustworthiness checking of the field replaceable unit may be implemented, the implementation is simple, and the cost is low.

Persons of ordinary skill in the art may understand that all or part of the steps of the method embodiment may be implemented by a program instructing relevant hardware. The program may be stored in a computer readable storage medium. When the program is executed, the steps of the method embodiment are performed. The storage medium includes various media that is may store program codes, such as a ROM, a RAM, a magnetic disk, a compact disk, and so on.

FIG. 2 is a schematic structural diagram of an embodiment of an apparatus for checking a field replaceable unit according to the present application. The apparatus for checking the field replaceable unit in this embodiment may implement the process of the embodiment shown in FIG. 1 of the present application. As shown in FIG. 2, the apparatus for checking the field replaceable unit may include: an

obtaining module 21 and a determining module 22, where the obtaining module 21 is configured to obtain key identifier information saved in a security memory module; and

the determining module 22 is configured to determine trustworthiness of the field replaceable unit according to the key identifier information that is saved in the security memory module and is obtained by the obtaining module 21 and key identifier information that is directly obtained from the field replaceable unit.

In this embodiment, the apparatus for checking the field replaceable unit may be configured in a communication device including the field replaceable unit, where the communication device may be a stored program control telephone switching system, a data communication device, a wireless communication device or an optical transmission device and so on, and may also be a server type device, including a minicomputer, a server or a computer and so on.

In the foregoing embodiment, after the obtaining module 21 obtains the key identifier information saved in the security memory module of the field replaceable unit, the determining module 22 may determine the trustworthiness of the field replaceable unit according to the key identifier information saved in the security memory module and the key identifier information directly obtained from the field replaceable unit, thereby implementing trustworthiness checking of the field replaceable unit, the implementation is simple, and the cost is low.

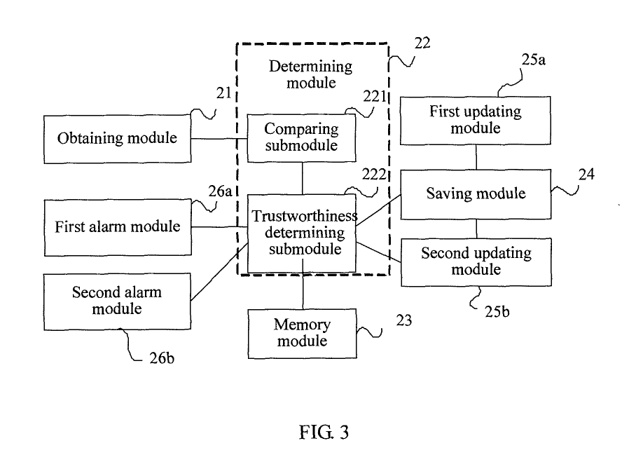

FIG. 3 is a schematic structural diagram of another embodiment of an apparatus for checking a field replaceable unit according to the present application. Compared with the apparatus for checking the field replaceable unit shown in FIG. 2, a difference lies in that, the determining module 22 may include: a comparing submodule 221 and a trustworthiness determining submodule 222, where

the comparing submodule 221 is configured to compare the key identifier information saved in the security memory module with the key identifier information directly obtained from the field replaceable unit; and

the trustworthiness determining submodule 222 is configured to, when the comparing submodule 221 determines that the key identifier information saved in the security memory module is consistent with the key identifier information directly obtained from the field replaceable unit, determine that the field replaceable unit is trustworthy, and when the comparing submodule 221 determines that the key identifier information saved in the security memory module is inconsistent with the key identifier information directly obtained from the field replaceable unit, determine that the field replaceable unit is untrustworthy.

Specifically, the comparing submodule 221 may decrypt the encrypted key identifier information saved in the security memory module, compare the decrypted key identifier information with the key identifier information directly obtained from the field replaceable unit; or, encrypt the key identifier information directly obtained from the field replaceable unit, and compare the key identifier information, which is directly obtained from the field replaceable unit and is encrypted, with the encrypted key identifier information saved in the security memory module, where an encryption algorithm adopted to encrypt the key identifier information directly obtained from the field replaceable unit is the same as an encryption algorithm adopted in the encrypted key identifier information saved in the security memory module.

Optionally, the apparatus for checking the field replaceable unit may further include:

a memory module 23, configured to store the trustworthiness of the field replaceable unit in a system status memory module.

Specifically, the obtaining module 21 may, after the field replaceable unit is received and before the field replaceable unit is used for the first time, obtain the key identifier information saved in the security memory module of the field replaceable unit; or, in a start process of the field replaceable unit, obtain the key identifier information saved in the security memory module of the field replaceable unit; or, after a field replaceable unit is newly inserted, obtain key identifier information saved in a security memory module of the newly inserted field replaceable unit; or, in a running process of the field replaceable unit, regularly or periodically obtain the key identifier information saved in the security memory module of the field replaceable unit; or, in the running process of the field replaceable unit, receive the key identifier information that is saved in the security memory module of the field replaceable unit and is reported by the field replaceable unit after the field replaceable unit is triggered by a command.

Optionally, the apparatus for checking the field replaceable unit may further include: a saving module 24, a first updating module 25a and a first alarm module 26a, where

in an implementation manner of this embodiment, the saving module 24 is configured to, in the start process of the field replaceable unit, if the determining module 22 determines that the field replaceable unit is trustworthy, allow the field replaceable unit to be registered, and save an electronic identifier used to uniquely identify the field replaceable unit in the system status memory module;

the first updating module 25a is configured to, after the field replaceable unit is successfully registered, update a status of the field replaceable unit in the system status memory module to an online status; and

the first alarm module 26a is configured to, in the start process of the field replaceable unit, if the determining module 22 determines that the field replaceable unit is untrustworthy, generate an alarm, and record an event that the field replaceable unit is untrustworthy in a log.

In another implementation manner of this embodiment, the apparatus for checking the field replaceable unit may further include: a second updating module 25b and a second alarm module 26b. The second updating module 25b is configured to, in the running process of the field replaceable unit, if the determining module 22 determines that the field replaceable unit is untrustworthy, bring the field replaceable unit offline, and update the status of the field replaceable unit in the system status memory module to an offline status.

The second alarm module 26b is configured to, in the running process of the field replaceable unit, if the determining module 22 determines that the field replaceable unit is untrustworthy, generate an alarm, and record an event that the field replaceable unit is untrustworthy in a log.

Optionally, the first alarm module 26a and the second alarm module 26b may be implemented in a same module or device, and the first updating module 25a and the second updating module 25b may also be implemented in a same module or device.

The foregoing apparatus for checking the field replaceable unit may implement trustworthiness checking of the field replaceable unit, the implementation is simple, and the cost is low.

An embodiment of the present application further provides a communication device. The communication device includes at least one field replaceable unit and at least one apparatus for checking the field replaceable unit. The apparatus for checking the field replaceable unit may be implemented through the apparatus for checking the field replaceable unit shown in FIG. 2 or FIG. 3 of the present application. The communication device may be a stored program control telephone switching system, a data communication device, a wireless communication device or an optical transmission device and so on, and may also be a server type device, including a minicomputer, a server or a computer and so on.

In the embodiment of the present application, one device may include multiple field replaceable units.

Persons skilled in the art may understand that the accompanying drawings are merely schematic diagrams of an exemplary embodiment, and modules or processes in the accompanying drawings are not necessarily required in implementing the present application.

Persons skilled in the art may understand that the modules in the apparatus provided in the embodiments may be distributed in the apparatus according to the description of the embodiments, or may be placed in one or multiple apparatuses, which are different from those described in the embodiments, after a corresponding change. The modules in the embodiments may be combined into one module, or split into multiple submodules.

Finally, it should be noted that the foregoing embodiments are merely used for describing the technical solutions of the present application other than limiting the present application. Although the present application is described in detail with reference to the foregoing embodiments, persons of ordinary skill in the art should understood that they may still make modifications to the technical solutions described in the foregoing embodiments, or make equivalent replacements to part of the technical features, and such modifications or replacements do not make the nature of corresponding technical solutions depart from the scope of the technical solutions of the embodiments of the present application.

What is claimed is:

1. A method for checking a field replaceable unit, comprising:
obtaining key identifier information saved in a security memory module; and
determining trustworthiness of the field replaceable unit according to the key identifier information saved in the security memory module and key identifier information directly obtained from the field replaceable unit.

2. The method according to claim 1, wherein the determining the trustworthiness of the field replaceable unit according to the key identifier information saved in the security memory module and the key identifier information directly obtained from the field replaceable unit comprises:
comparing the key identifier information saved in the security memory module with the key identifier information directly obtained from the field replaceable unit;
if the key identifier information saved in the security memory module is consistent with the key identifier information directly obtained from the field replaceable unit, determining that the field replaceable unit is trustworthy; and
if the key identifier information saved in the security memory module is inconsistent with the key identifier information directly obtained from the field replaceable unit, determining that the field replaceable unit is untrustworthy.

3. The method according to claim 2, wherein the key identifier information saved in the security memory module comprises: encrypted key identifier information, and
the comparing the key identifier information saved in the security memory module with the key identifier information directly obtained from the field replaceable unit comprises:
decrypting the encrypted key identifier information saved in the security memory module, and comparing the decrypted key identifier information with the key identifier information directly obtained from the field replaceable unit; or
encrypting the key identifier information directly obtained from the field replaceable unit, comparing the key identifier information, which is directly obtained from the field replaceable unit and is encrypted, with the encrypted key identifier information saved in the security memory module, wherein an encryption algorithm adopted to encrypt the key identifier information directly obtained from the field replaceable unit is the same as an encryption algorithm adopted in the encrypted key identifier information saved in the security memory module.

4. The method according to claim 3, wherein the encrypted key identifier information saved in the security memory module comprises one or any combination of the following: a ciphertext of an electronic identifier used to uniquely identify the field replaceable unit, a digest ciphertext of an identifier and topology of a key chip in the field replaceable unit, a digest ciphertext of a read only memory program area in the field replaceable unit, and a digest ciphertext of a system software program area or another software program area except the system software program area in the field replaceable unit.

5. The method according to claim 3, wherein the decrypting the encrypted key identifier information saved in the security memory module, and comparing the decrypted key identifier information with the key identifier information directly obtained from the field replaceable unit comprises:
decrypting the ciphertext of the electronic identifier used to uniquely identify the field replaceable unit, wherein the ciphertext is saved in the security memory module, and comparing the decrypted electronic identifier with an electronic identifier directly read from the field replaceable unit; and/or
decrypting the digest ciphertext of the identifier and the topology of the key chip in the field replaceable unit, wherein the digest ciphertext is saved in the security memory module, generating a digest of an identifier and topology of the key chip in the field replaceable unit according to the identifier and the topology of the key chip in the field replaceable unit, wherein the identifier and the topology are directly read from the field replaceable unit, and comparing the decrypted digest of the identifier and the topology of the key chip in the field replaceable unit with the generated digest of the identifier and the topology of the key chip in the field replaceable unit; and/or
decrypting the digest ciphertext of the read only memory program area in the field replaceable unit, wherein the digest ciphertext is saved in the security memory module, generating a digest of a read only memory program area in the field replaceable unit according to information of the read only memory program area in the field replaceable unit, wherein the information is directly read from the field replaceable unit, and comparing the decrypted digest of the read only memory program area in the field replaceable unit with the generated digest of the read only memory program area in the field replaceable unit; and/or
decrypting the digest ciphertext of the system software program area or another software program area except the system software program area in the field replaceable unit, wherein the digest ciphertext is saved in the security memory module, generating a digest of a system software program area or another software program area except the system software program area in the field replaceable unit according to information of the system software program area or another software program area except the system software program area in the field replaceable unit, wherein the digest ciphertext is directly read from the field replaceable unit, and comparing the decrypted digest of the system software program area or another software program area except the system software program area in the field replaceable unit with the generated digest of the system software program area or another software program area except the system software program area in the field replaceable unit.

6. The method according to claim 1, wherein after the determining the trustworthiness of the field replaceable unit according to the key identifier information saved in the security memory module and the key identifier information directly obtained from the field replaceable unit, the method further comprises:
storing the trustworthiness of the field replaceable unit in a system status memory module.

7. The method according to claim 1, wherein the obtaining the key identifier information saved in the security memory module comprises:
after the field replaceable unit is received, and before the field replaceable unit is used for the first time, obtaining the key identifier information saved in the security memory module of the field replaceable unit; or
in a start process of the field replaceable unit, obtaining the key identifier information saved in the security memory module of the field replaceable unit; or
in a running process of the field replaceable unit, regularly or periodically obtaining the key identifier information saved in the security memory module of the field replaceable unit; or
in the running process of the field replaceable unit, receiving the key identifier information that is saved in the security memory module of the field replaceable unit and is reported by the field replaceable unit after the field replaceable unit is triggered by a command.

8. The method according to claim 7, further comprising:
in the start process of the field replaceable unit, if it is determined that the field replaceable unit is trustworthy, allowing the field replaceable unit to be registered, saving the electronic identifier used to uniquely identify the field replaceable unit in a system status memory module, and after the field replaceable unit is successfully registered, updating a status of the field replaceable unit in the system status memory module to an online status; and
if it is determined that the field replaceable unit is untrustworthy, generating an alarm, and recording an event that the field replaceable unit is untrustworthy in a log.

9. The method according to claim 7, further comprising:
in the running process of the field replaceable unit, if it is determined that the field replaceable unit is untrustworthy, bringing the field replaceable unit offline, updating a status of the field replaceable unit in a system status memory module to an offline status, outputting alarm information, and recording an event that the field replaceable unit is untrustworthy in a log.

10. An apparatus for checking a field replaceable unit, comprising:
an obtaining module, configured to obtain key identifier information saved in a security memory module; and
a determining module, configured to determine trustworthiness of the field replaceable unit according to the key identifier information that is saved in the security memory module and is obtained by the obtaining module and key identifier information directly obtained from the field replaceable unit.

11. The apparatus according to claim 10, wherein the determining module comprises:
a comparing submodule, configured to compare the key identifier information saved in the security memory module with the key identifier information directly obtained from the field replaceable unit; and
a trustworthiness determining submodule, configured to, when the comparing submodule determines that the key identifier information saved in the security memory module is consistent with the key identifier information directly obtained from the field replaceable unit, determine that the field replaceable unit is trustworthy, and when the comparing submodule determines that the key identifier information saved in the security memory module is inconsistent with the key identifier information directly obtained from the field replaceable unit, determine that the field replaceable unit is untrustworthy.

12. The apparatus according to claim 11, wherein
the comparing submodule is specifically configured to:
decrypt encrypted key identifier information saved in the security memory module, and compare the decrypted key identifier information with the key identifier information directly obtained from the field replaceable unit; or
encrypt the key identifier information directly obtained from the field replaceable unit, and compare the key identifier information, which is directly obtained from the field replaceable unit and is encrypted, with encrypted key identifier information saved in the security memory module, wherein
an encryption algorithm adopted to encrypt the key identifier information directly obtained from the field replaceable unit is the same as an encryption algorithm adopted in the encrypted key identifier information saved in the security memory module.

13. The apparatus according to claim 10, further comprising,
a memory module, configured to store the trustworthiness of the field replaceable unit in a system status memory module.

14. The apparatus according to claim 10, wherein
the obtaining module is specifically configured to:
after the field replaceable unit is received, and before the field replaceable unit is used for the first time, obtain the key identifier information saved in the security memory module of the field replaceable unit; or
in a start process of the field replaceable unit, obtain the key identifier information saved in the security memory module of the field replaceable unit; or
after a field replaceable unit is newly inserted, obtain key identifier information saved in a security memory module of the newly inserted field replaceable unit; or
in a running process of the field replaceable unit, obtain the key identifier information saved in the security memory module of the field replaceable unit regularly or periodically; or
in the running process of the field replaceable unit, receive the key identifier information that is saved in the security memory module of the field replaceable unit and is reported by the field replaceable unit after the field replaceable unit is triggered by a command.

15. The apparatus according to claim 14, further comprising: a saving module, a first updating module and a first alarm module, wherein
the saving module is configured to, in the start process of the field replaceable unit, if the determining module determines that the field replaceable unit is trustworthy, allow the field replaceable unit to be registered, and save an electronic identifier used to uniquely identify the field replaceable unit in a system status memory module;
the first updating module is configured to, after the field replaceable unit is successfully registered, update a status of the field replaceable unit in the system status memory module to an online status; and
the first alarm module is configured to, in the start process of the field replaceable unit, if the determining module determines that the field replaceable unit is untrustworthy, generate an alarm, and record an event that the field replaceable unit is untrustworthy in a log.

16. The apparatus according to claim 14, further comprising: a second updating module and a second alarm module, wherein
the second updating module is configured to, in the running process of the field replaceable unit, if the determining module determines that the field replaceable unit is untrustworthy, bring the field replaceable unit offline, and update a status of the field replaceable unit in a system status memory module to an offline status; and
the second alarm module is configured to, in the running process of the field replaceable unit, if the determining module determines that the field replaceable unit is untrustworthy, generate an alarm, and record an event that the field replaceable unit is untrustworthy in a log.

17. A communication device, comprising: at least one field replaceable unit and at least one apparatus for checking the field replaceable unit, wherein the apparatus comprise:
an obtaining module, configured to obtain key identifier information saved in a security memory module; and
a determining module, configured to determine trustworthiness of the field replaceable unit according to the key identifier information that is saved in the security memory module and is obtained by the obtaining module and key identifier information directly obtained from the field replaceable unit.

18. The communication device according to claim 17, wherein the determining module comprises:
a comparing submodule, configured to compare the key identifier information saved in the security memory module with the key identifier information directly obtained from the field replaceable unit; and
a trustworthiness determining submodule, configured to, when the comparing submodule determines that the key identifier information saved in the security memory module is consistent with the key identifier information directly obtained from the field replaceable unit, determine that the field replaceable unit is trustworthy, and when the comparing submodule determines that the key identifier information saved in the security memory module is inconsistent with the key identifier information directly obtained from the field replaceable unit, determine that the field replaceable unit is untrustworthy.

19. The communication device according to claim 18, wherein
the comparing submodule is specifically configured to:
decrypt encrypted key identifier information saved in the security memory module, and compare the decrypted key identifier information with the key identifier information directly obtained from the field replaceable unit; or
encrypt the key identifier information directly obtained from the field replaceable unit, and compare the key identifier information, which is directly obtained from the field replaceable unit and is encrypted, with encrypted key identifier information saved in the security memory module, wherein
an encryption algorithm adopted to encrypt the key identifier information directly obtained from the field replaceable unit is the same as an encryption algorithm adopted in the encrypted key identifier information saved in the security memory module.

20. The communication device according to claim 17, further comprising,
a memory module, configured to store the trustworthiness of the field replaceable unit in a system status memory module.

21. The communication device according to claim 17, wherein
the obtaining module is specifically configured to:
after the field replaceable unit is received, and before the field replaceable unit is used for the first time, obtain the key identifier information saved in the security memory module of the field replaceable unit; or
in a start process of the field replaceable unit, obtain the key identifier information saved in the security memory module of the field replaceable unit; or
after a field replaceable unit is newly inserted, obtain key identifier information saved in a security memory module of the newly inserted field replaceable unit; or
in a running process of the field replaceable unit, obtain the key identifier information saved in the security memory module of the field replaceable unit regularly or periodically; or
in the running process of the field replaceable unit, receive the key identifier information that is saved in the security memory module of the field replaceable unit and is reported by the field replaceable unit after the field replaceable unit is triggered by a command.

22. The communication device according to claim 21, further comprising: a saving module, a first updating module and a first alarm module, wherein
the saving module is configured to, in the start process of the field replaceable unit, if the determining module determines that the field replaceable unit is trustworthy, allow the field replaceable unit to be registered, and save an electronic identifier used to uniquely identify the field replaceable unit in a system status memory module;
the first updating module is configured to, after the field replaceable unit is successfully registered, update a status of the field replaceable unit in the system status memory module to an online status; and
the first alarm module is configured to, in the start process of the field replaceable unit, if the determining module determines that the field replaceable unit is untrustworthy, generate an alarm, and record an event that the field replaceable unit is untrustworthy in a log.

23. The communication device according to claim 21, further comprising: a second updating module and a second alarm module, wherein
the second updating module is configured to, in the running process of the field replaceable unit, if the determining module determines that the field replaceable unit is untrustworthy, bring the field replaceable unit offline, and update a status of the field replaceable unit in a system status memory module to an offline status; and
the second alarm module is configured to, in the running process of the field replaceable unit, if the determining module determines that the field replaceable unit is untrustworthy, generate an alarm, and record an event that the field replaceable unit is untrustworthy in a log.
